(19) United States
(12) Patent Application Publication
(10) Pub. No.: US 2024/0422303 A1
(43) Pub. Date: Dec. 19, 2024

(54) SURFACE-DIVIDED POLARIZATION CONVERSION COMPONENT, AND DISPLAY DEVICE

(71) Applicant: Sharp Display Technology Corporation, Kameyama City (JP)

(72) Inventor: Naru USUKURA, Kameyama City (JP)

(21) Appl. No.: 18/641,990

(22) Filed: Apr. 22, 2024

(30) Foreign Application Priority Data
Jun. 13, 2023 (JP) 2023-097116

(51) Int. Cl. H04N 13/337; G02B 3/00; G02B 3/14; G02B 5/30; H04N 13/156

(52) U.S. Cl. CPC H04N 13/337; G02B 3/0087; G02B 3/14; G02B 5/3083; H04N 13/156

(57) ABSTRACT

Provided are a surface-divided polarization conversion component capable of generating from one display panel two images at different virtual image distances, and a display device using the surface-divided polarization conversion component. The surface-divided polarization conversion component includes, in a plan view: a first transmissive part which transmits polarized light for a first image; and a second transmissive part which transmits polarized light for a second image, the second transmissive part introducing a phase difference different by λ/2 from a phase difference introduced by the first transmissive part.

### CROSS-REFERENCE TO RELATED APPLICATIONS

The present application claims priority under 35 U.S.C. § 119 to Japanese Patent Application No. 2023-097116 filed on Jun. 13, 2023, the contents of which are incorporated herein by reference in their entirety.

### BACKGROUND OF THE INVENTION

### Field of the Invention

The following disclosure relates to surface-divided polarization conversion components and display devices using the surface-divided polarization conversion components.

### Description of Related Art

Recent years have seen a growing attention to a three-dimensional virtual space called metaverse. VR-HMDs are a tool (product) to access the metaverse, and thus their market is expected to grow. VR-HMDs, however, induces a condition called VR motion sickness (or 3D motion sickness), which has been an obstacle to use of a VR-HMD for a long time and to VR market penetration.

A technique relating to three-dimensional display is disclosed in, for example, JP 2002-156603 A. The technique disclosed is a three-dimensional display method including generating a two-dimensional image by projecting from the gaze directions of the viewer's eyes an object to be displayed onto multiple display surfaces arranged at different depth positions as seen from a viewer, displaying the generated two-dimensional image on each of any two display surfaces among the multiple display surfaces, and varying the luminance values of the displayed two-dimensional images on the individual two display surfaces among the multiple display surfaces independently to generate a three-dimensional stereoscopic image, wherein polarization-type multifocal optics is used to form images of the display light for a two-dimensional image on the individual two display surfaces among the multiple display surfaces while the polarization direction of the display light is controlled to independently vary the luminance values of the two-dimensional images formed on the individual two display surfaces among the multiple display surfaces.

### BRIEF SUMMARY OF THE INVENTION

The technique disclosed in JP 2002-156603 A allows three-dimensional display seen with the naked eyes, which however requires high-speed driving. High-speed driving tends to cause flickers and blurriness of images (also called “video”) and require an expensive system. The technique also tends to require a large enclosure.

The VR motion sickness is known to be induced by the fixed virtual image distances. Thus, the virtual image distances are desired to be variable mainly in the HMDs (for VR), and use of a liquid crystal lens has thus been considered. However, a conventional method using a liquid crystal lens moves one screen entirely closer to or away from the user, and it is difficult to move only part of the screen by the method.

In response to the above issues, an object of the present invention is to provide a surface-divided polarization conversion component capable of generating from one display panel two images at different virtual image distances, and a display device using the surface-divided polarization conversion component.
(1) One embodiment of the present invention is directed to a surface-divided polarization conversion component including, in a plan view: a first transmissive part which transmits polarized light for a first image; and a second transmissive part which transmits polarized light for a second image, the second transmissive part introducing a phase difference different by λ/2 from a phase difference introduced by the first transmissive part.
(2) In an embodiment of the present invention, the surface-divided polarization conversion component includes the structure (1), the first transmissive part is a non-conversion part which transmits polarized light for a first image without converting a polarization state of the polarized light, and the second transmissive part is a conversion part which converts a polarization state of polarized light for a second image by introducing a phase difference of λ/2 to the polarized light for a second image.
(3) In an embodiment of the present invention, the surface-divided polarization conversion component includes the structure (2), and the conversion part includes a resin layer with a phase difference of λ/2.
(4) In an embodiment of the present invention, the surface-divided polarization conversion component includes the structure (1), (2), or (3), the second transmissive part in a cross-sectional view includes a pair of substrates and a liquid crystal layer placed between the pair of substrates, and the second transmissive part introduces a phase difference that is variable depending on voltage applied to the liquid crystal layer.
(5) Another embodiment of the present invention is directed to a display device including: a display panel configured to emit polarized light for a first image and polarized light for a second image; the surface-divided polarization conversion component including the structure (1), (2), (3), or (4) placed at a position where the polarized lights enter; and an optical element placed at a position where the polarized lights transmitted through the surface-divided polarization conversion component enter, the optical element being configured to make a virtual image distance of a first image generated from the first polarized light transmitted through the first transmissive part different from a virtual image distance of a second image generated from the second polarized light transmitted through the second transmissive part.
(6) In an embodiment of the present invention, the display device includes the structure (5), the optical element is a liquid crystal lens, and the liquid crystal lens acts as a lens with a first focal length for the first polarized light and does not act as a lens or acts as a lens with a second focal length for the second polarized light.
(7) In an embodiment of the present invention, the display device includes the structure (6), and the liquid crystal lens is a refractive lens, a gradient-index lens, or a diffractive lens.
(8) In an embodiment of the present invention, the display device includes the structure (6), and the liquid crystal lens is a Pancharatnam-Berry phase lens.
(9) In an embodiment of the present invention, the display device includes the structure (6), and the liquid crystal lens includes a liquid crystal layer and has a focal length that is variable depending on voltage applied to the liquid crystal layer.
(10) In an embodiment of the present invention, the display device includes the structure (5), (6), (7), (8), or (9), and further includes a different lens other than a liquid crystal lens.
(11) In an embodiment of the present invention, the display device includes the structure (6), (7), (8), (9), or (10), and further includes a combination of a different surface-divided polarization conversion component and a different liquid crystal lens.
(12) In an embodiment of the present invention, the display device includes the structure (5), (6), (7), (8), (9), (10), or (11), and the display device is configured to execute first image correction for an overlapping region between the first image and the second image.
(13) In an embodiment of the present invention, the display device includes the structure (12), and the first image correction includes making the overlapping region appear black.
(14) In an embodiment of the present invention, the display device includes the structure (12), and the first image correction decreases luminance of at least one of the first image or the second image in the overlapping region.
(15) In an embodiment of the present invention, the display device includes the structure (12), (13), or (14), and the first image correction includes determining the overlapping region based on an amount of overlap between the first image and the second image detected by eye tracking.
(16) In an embodiment of the present invention, the display device includes the structure (5), (6), (7), (8), (9), (10), (11), (12), (13), (14), or (15), and further includes a guest-host liquid crystal layer between the surface-divided polarization conversion component and the optical element, wherein the guest-host liquid crystal layer contains a light absorbing material as a guest material and contains a liquid crystal as a host material.
(17) In an embodiment of the present invention, the display device includes the structure (5), (6), (7), (8), (9), (10), (11), (12), (13), (14), (15), or (16), and the display device is configured to execute second image correction for a boundary region between the first image and the second image.
(18) In an embodiment of the present invention, the display device includes the structure (17), and the second image correction includes superimposing the first image and the second image by time-division display.
(19) In an embodiment of the present invention, the display device includes the structure (5), (6), (7), (8), (9), (10), (11), (12), (13), (14), (15), (16), (17), or (18), and is a VR display device or a 3D display device.
(20) In an embodiment of the present invention, the display device includes the structure (5), (6), (7), (8), (9), (10), (11), (12), (13), (14), (15), (16), (17), (18), or (19), and is a head-mounted display device.

The present invention can provide a surface-divided polarization conversion component capable of generating from one display panel two images at different virtual image distances, and a display device using the surface-divided polarization conversion component.

### BRIEF DESCRIPTION OF THE DRAWINGS

FIG. 1 shows the display principle of a virtual image in a display device.

FIG. 2 shows a conventional VR display principle.

FIG. 3 shows the state where the human eyes see an actual object.

FIG. 4 shows the display state in one virtual image plane.

FIG. 5 shows the display state in two virtual image planes.

FIG. 6 is a schematic side view of the configuration of a display device of Embodiment 1.

FIG. 7 shows the structure of a refractive lens made of a resin, with the upper part showing a cross-sectional view and the lower part showing a top view.

FIG. 8 shows the operation of the refractive lens at an azimuth A indicated in FIG. 7, with the upper part showing the state with voltage applied to the liquid crystal layer and the lower part showing the state with no voltage applied to the liquid crystal layer.

FIG. 9 shows the operation of the refractive lens at an azimuth B indicated in FIG. 7, with the upper part showing the state with voltage applied to the liquid crystal layer and the lower part showing the state with no voltage applied to the liquid crystal layer.

FIG. 10 is a top view showing the configuration of a Pancharatnam-Berry phase lens.

FIG. 11 shows the functions of a Pancharatnam-Berry phase lens.

FIG. 12 is a side view showing an example of a specific configuration of a display device of Embodiment 1.

FIG. 13 is a bird's-eye view of the display device shown in FIG. 12.

FIG. 14 is an enlarged cross-sectional view of a surface-divided polarization conversion component of Embodiment 1.

FIG. 15 is a side view showing another example of the specific configuration of the display device of Embodiment 1.

FIG. 16 is a side view schematically showing the configuration of a display device of Embodiment 2.

FIG. 17 is a side view schematically showing the configuration of a display device of Embodiment 3.

FIG. 18 shows how pixels in the boundary appear when a surface-divided polarization conversion component is spaced from the display surface.

FIG. 19 shows the generation principle of an overlap and a gap between videos.

FIG. 20 is a side view schematically showing the configuration of a display device with an overlap between virtual images.

FIG. 21 is a front view of an example of a display surface when there is an overlap between virtual images.

FIG. 22 is a front view of an example of a video when there is an overlap between virtual images.

FIG. 23 shows first correction applied to an overlap between virtual image planes, showing the original image.

FIG. 24 shows first correction applied to an overlap between virtual image planes, showing an enlarged image.

FIG. 25 shows second correction applied to an overlap between virtual image planes, showing the original image.

FIG. 26 shows second correction applied to an overlap between virtual image planes, showing an enlarged image.

FIG. 27 shows third correction applied to an overlap between virtual image planes.

FIG. 28 is a flowchart showing an example of image correction when the eye tracking technology is used.

FIG. 29 shows first correction when the eye tracking technology is used, showing the original image.

FIG. 30 shows first correction when the eye tracking technology is used, showing an enlarged image.

FIG. 31 shows the generation principle of a gap between virtual images, showing the original image.

FIG. 32 shows the generation principle of a gap between virtual images, showing an enlarged image.

FIG. 33 shows time-division display.

FIG. 34 shows the relationship between the focal length of a lens and a virtual image.

FIG. 35 is a side view schematically showing the configuration of a display device of Embodiment 5.

### DETAILED DESCRIPTION OF THE INVENTION

The following describes embodiments of the present invention. The present invention is not limited to the following embodiments. The design may be modified as appropriate within the range satisfying the configuration of the present invention. In the following description, components having the same or similar functions in different drawings are commonly provided with the same reference sign so as to appropriately avoid repetition of description. The structures in the present invention may be combined as appropriate without departing from the gist of the present invention.

A surface-divided polarization conversion component of the present invention is one placed inside a display device and capable of generating from one display panel two images at different virtual image distances. The types of the display device include virtual reality (VR) display devices which display the content compatible with the VR technology and 3D display devices which display three-dimensional images. The display device is preferably a head-mounted display device (HMD). A head-mounted display device (HMD) is a display device in a head-wearable form and, for example, has the shape of goggles to be worn on the head of the user such that a display such as a liquid crystal display comes in front of the eyes of the user when it is worn. Such an HMD is suitable for viewing the content compatible with the virtual reality (VR) technology. Examples of the configuration of an HMD include one having a support for wearing on the head of the user and a display with a liquid crystal module, wherein the display comes in front of the eyes of the user when the device is worn.

When two images at different virtual image distances are generated using the surface-divided polarization conversion component of the present invention, the burden on the user (viewer) during viewing of the display device can be reduced or the sense of immersion into the content can be enhanced.

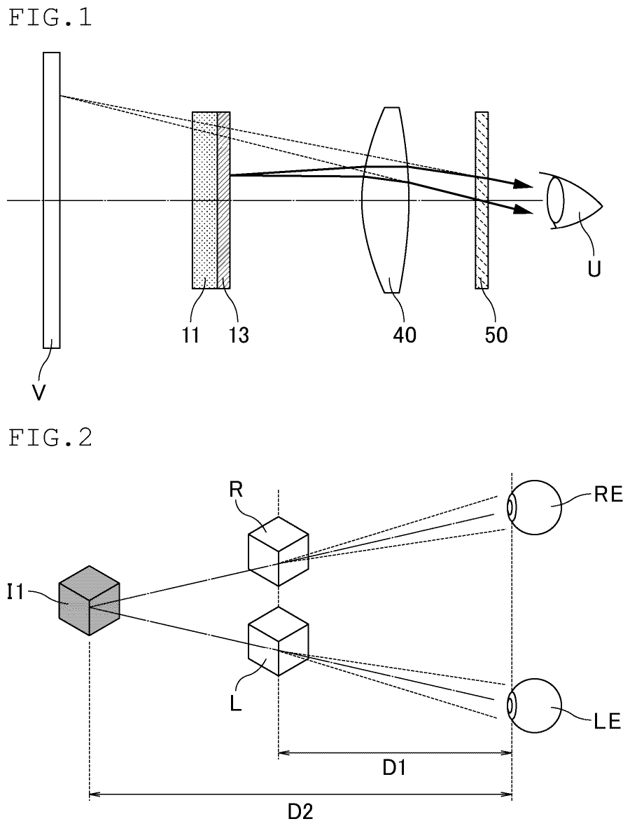

FIG. 1 shows the display principle of a virtual image in a display device. In the attached drawings, a dashed and dotted line indicates the direction normal to the display surface of the display 11, a solid line arrow indicates the path of light for displaying a real image traveling from the display surface of the display 11 toward the user U's eyes, and a dotted line arrow indicates the path of light for displaying a virtual image traveling from the display surface of the display 11 toward the user U's eyes.

The display device in FIG. 1 includes, sequentially from the user U side, a liquid crystal lens 50 whose focal length is adjustable, a lens (physical lens) 40 whose focal length is constant, a polarizing plate 13, and a display 11. In cases of a device such as a head-mounted display device (HMD), the distance from the liquid crystal lens 50 to the display 11 is short, so that the user U perceives a virtual image V behind the display 11. Varying the focal length of the liquid crystal lens 50 moves the position of the virtual image V closer to or away from the user U. Whether the virtual image V moves intermittently or continuously depends on the system of the liquid crystal lens 50. In the display device in FIG. 1, the virtual image V, displayed at a specific timing, is formed only at a specific distance. In other words, the virtual image V is displayed in one plane. Hereinafter, the plane in which the virtual image V is displayed is also referred to as a “virtual image plane”.

Next, issues in use of virtual images for display are described based on a VR display device which is a typical example of a display device that uses virtual images for display. Known issues include VR motion sickness, which is caused by the following mechanism.

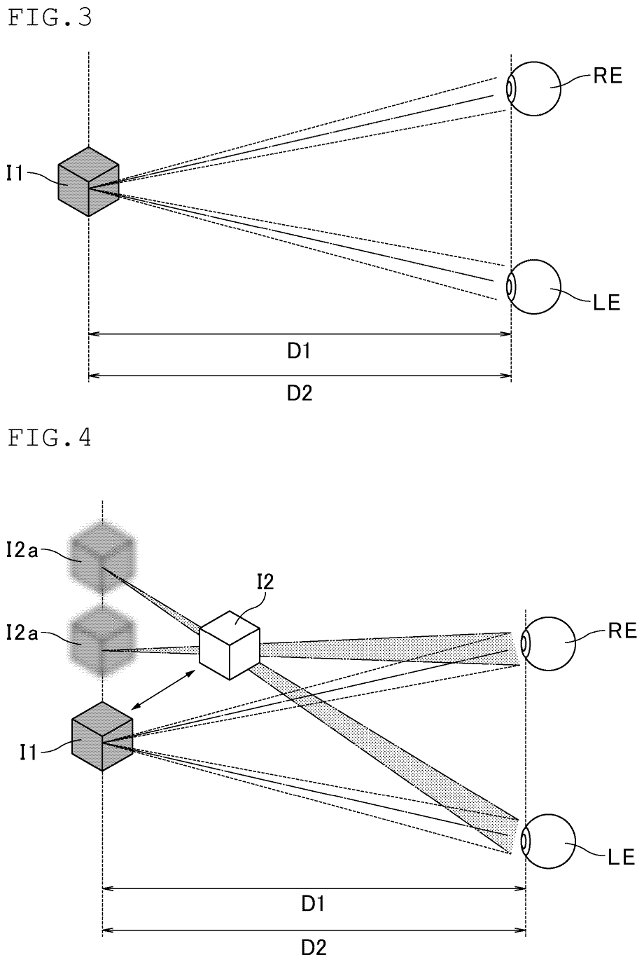

FIG. 2 shows a conventional VR display principle. As shown in FIG. 2, VR display separately displays a video R intended for the right eye and a video L intended for the left eye to cause the user U to perceive a video Il at the position where a 3D video is intended to be displayed. FIG. 3 shows the state where the human eyes see an actual object. As is understood from the comparison between FIGS. 2 and 3, the conventional VR creates a state different from the state where the human eyes see an actual object in that the movement where the right eye RE and the left eye LE rotate toward the image I1 (convergence) is inconsistent with the focus adjustment. VR motion sickness is considered to occur due to the difference between the distance of focus adjustment (distance to the image R intended for the right eye and distance to the image L intended for the left eye), D1, and the distance to the eyes' gaze point, D2. This is because the image R intended for the right eye and the image L intended for the left eye are virtual images and thus the virtual image planes (virtual image distances) cannot be moved. When the virtual image planes can be moved using a liquid crystal lens whose focal length is adjustable, for example, the state shown in FIG. 3 can be achieved, so that the VR motion sickness can be prevented.

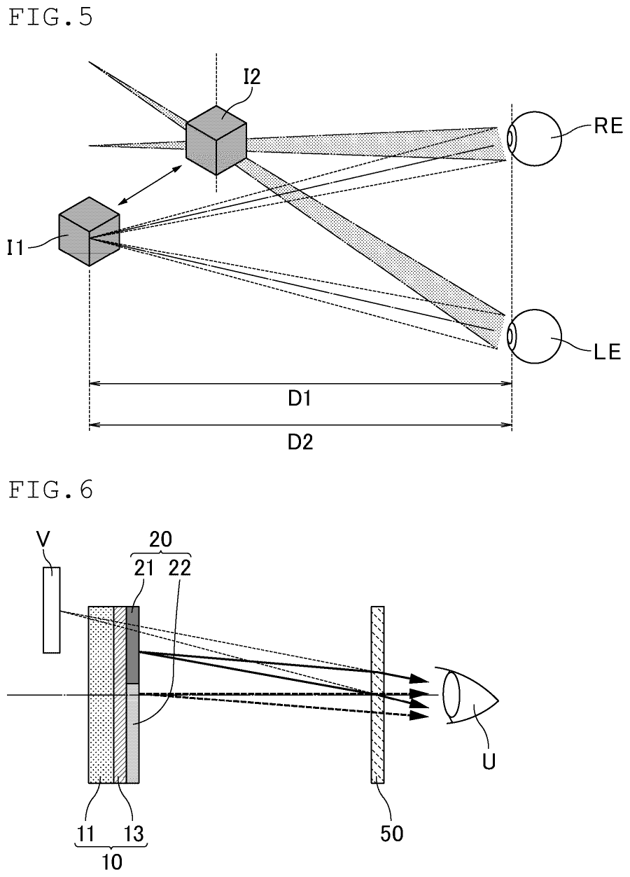

Meanwhile, in displaying an image with a stereoscopic effect (3D image) by the VR technology, as compared to the state where one sees an actual object, it is difficult to completely eliminate the uncomfortable feeling by simply moving the virtual images using a liquid crystal lens whose focal length is adjustable, for example. FIG. 4 shows the display state in one virtual image plane. FIG. 5 shows the display state in two virtual image planes. When there is only one virtual image plane, how to express the objects in the peripheral vision is the problem. Specifically, as shown in FIG. 4, when one's eyes focus on the position of the image I1, then an image I2, which is an object at a closer position, should appear blurred. With one virtual image plane, two blurred images I2a for the right eye and the left eye can be displayed in one virtual image plane to cause the viewer to perceive a blurred image I2, thus making the viewer feel that the image I2 is in the peripheral vision. In this case, however, both liquid crystal lenses and the images need switching when the gaze point is switched between the position of the image I1 and the position of the image I2, and it is difficult to completely eliminate the uncomfortable feeling in seeing the blurry state expressed using images. In contrast, with two virtual image planes as shown in FIG. 5, there is no need to switch the liquid crystal lenses and the images in gaze switching between the positions, allowing smooth gaze switching and a favorable sense of immersion. The present invention thus generates two virtual image planes (two images at different virtual image distances).

### Embodiment 1

FIG. 6 is a schematic side view of the configuration of a display device of Embodiment 1. The display device in FIG. 6 includes, sequentially from the user U side, a liquid crystal lens (optical element) 50 whose focal length is adjustable, a surface-divided polarization conversion component 20, a polarizing plate 13, and a display 11.

The display 11 and the polarizing plate 13 in combination define a display panel 10 which emits polarized light. When one of the two images at different virtual image distances is defined as a “first image” and the other as a “second image”, the display panel emits polarized light for a first image and polarized light for a second image. The polarized light for a first image and the polarized light for a second image are transmitted through the surface-divided polarization conversion component 20 to enter the liquid crystal lens 50 whose focal length is adjustable.

Examples of the display 11 include liquid crystal display devices (LCDs) and self-luminous displays such as organic EL display devices (OLEDs). The polarizing plate 13 used is a linear polarizer which transmits polarized light (first polarized light component) vibrating in a certain one direction and absorbs or reflects polarized light (second polarized light component) vibrating in a direction orthogonal to the certain one direction.

The surface-divided polarization conversion component 20 in a plan view includes a first transmissive part which transmits polarized light for a first image and a second transmissive part which transmits polarized light for a second image. The second transmissive part is a region that introduces a phase difference different by λ/2 from a phase difference introduced by the first transmissive part. When polarized light for a first image is transmitted through the first transmissive part and polarized light for a second image is transmitted through the second transmissive part, a phase difference of λ/2 can be introduced between the polarized light for a first image and the polarized light for a second image. The display device shown in FIG. 6 uses the phase difference, λ/2, to make the virtual image distances of the two images different. When “a phase difference of λ/2” is introduced, this means that a phase difference corresponding to half the wavelength of light transmitted is introduced to the light; for example, a phase difference of 200 nm or more and 350 nm or less is introduced to light with a wavelength of 550 nm.

In the present embodiment, the surface-divided polarization conversion component 20 is a component in which the first transmissive part is a non-conversion part 22 which transmits polarized light for a first image with no change in the polarization state and the second transmissive part is a conversion part 21 which introduces a phase difference of λ/2 to polarized light for a second image to change the polarization state of the light. The expression “with no change in the polarization state” means that, for example, the phase difference to be introduced to light with a wavelength of 550 nm is 10 nm or less.

The surface-divided polarization conversion component 20 can be one that variably forms two or more parts introducing phase differences different by λ/2 from each other in a plane parallel to the display surface of the display 11. For example, a liquid crystal panel can be used. In other words, in the surface-divided polarization conversion component 20, the conversion part (second transmissive part) 21 in a cross-sectional view includes a pair of substrates and a liquid crystal layer placed between the pair of substrates, and may introduce a phase difference variable depending on the voltage applied to the liquid crystal layer. In a configuration where two or more parts introducing phase differences different by λ/2 from each other are formed, the arrangement of the conversion part (second transmissive part) 21 and the non-conversion part (first transmissive part) 22 in the plane is switchable (ON/OFF) with time. Specifically, when voltage is applied to the liquid crystal layer, a region functioning as the conversion part 21 at a certain time point becomes the non-conversion part 22, and a region functioning as the non-conversion part 22 at the certain time point becomes the conversion part 21. Thus, preferably, the entirety of the surface-divided polarization conversion component 20 is a liquid crystal panel.

The surface-divided polarization conversion component 20 can be one steadily including two or more parts with phase differences different by λ/2 from one another in a plane parallel to the display surface of the display 11, such as a surface-divided component in which the non-conversion part 22 is a transparent component and the conversion part 21 is a λ/2 plate. The λ/2 plate is a component that introduces a phase difference corresponding to half the wavelength of visible light to the visible light, such as a component that introduces a phase difference of 200 nm or more and 350 nm or less to light with a wavelength of 550 nm. When a λ/2 plate is used, the arrangement of the conversion part (second transmissive part) 21 and the non-conversion part (first transmissive part) 22 in the plane is not switched (ON/OFF) with time.

The surface-divided component can be produced, for example, by a method including attaching a resin film with a phase difference of λ/2 to the entire surface of a support component such as a glass substrate, and patterning the resin film to leave the resin film in the conversion part 21, thus forming a resin layer. Alternatively, the surface-divided component may be produced by a method including attaching a resin film with a phase difference of λ/2 only to a region of a support component corresponding to the conversion part 21. Also, instead of a resin film with a phase difference of λ/2, a resin layer with a phase difference of λ/2 may be formed on a support component. For example, a method may be used including forming an alignment film on a support component, forming a layer made of a photopolymerizable liquid crystal material on the alignment film, and curing the photopolymerizable liquid crystal material into a resin layer.

At a position where the polarized lights transmitted through the surface-divided polarization conversion component 20 enter, an optical element is placed that makes the virtual image distance of the first image generated from the first polarized light transmitted through the non-conversion part (first transmissive part) 22 different from the virtual image distance of the second image generated from the second polarized light transmitted through the conversion part (second transmissive part) 21. The optical element corresponds to the liquid crystal lens 50 whose focal length is adjustable in the present embodiment. The liquid crystal lens 50 acts as a lens with a first focal length for the first polarized light and does not act as a lens (does not bend the path of light) or acts as a lens with a second focal length for the second polarized light. For example, when the vibration direction of polarized light emitted from the display panel 10 matches the direction in which the liquid crystal lens 50 acts, the first polarized light transmitted through the non-conversion part 22 shows the virtual image V, and the second polarized light whose vibration direction is changed 90 degrees by the conversion part 21 is not affected by the liquid crystal lens 50 and thus shows the real image (display screen of the display panel). Thus, two virtual image distances (including cases where one of them is a real image distance) can be achieved using one display panel, so that a smooth gaze switching including the above-described peripheral vision can be achieved.

Non-limiting examples of the type of the liquid crystal lens 50 include refractive lenses, gradient-index (GRIN) lenses, and diffractive lenses. The gradient-index (GRIN) lenses are lenses that bend the path of light by the liquid crystal alignment. These liquid crystal lenses commonly act as a lens for linearly polarized light vibrating in one direction but do not act as a lens for linearly polarized light vibrating in the other direction. When the liquid crystal material is a curable material, the focal length of the liquid crystal lens is fixed. In contrast, when the liquid crystal material is movable, the focal length of the lens can be variable. The focal length can be controlled by voltage in the case of refractive lenses, by both voltage and liquid crystal alignment period in the case of gradient-index lenses, and by liquid crystal alignment period in the case of diffractive lenses. Preferably, the liquid crystal lens includes a liquid crystal layer and has a focal length variable depending on the voltage applied to the liquid crystal layer.

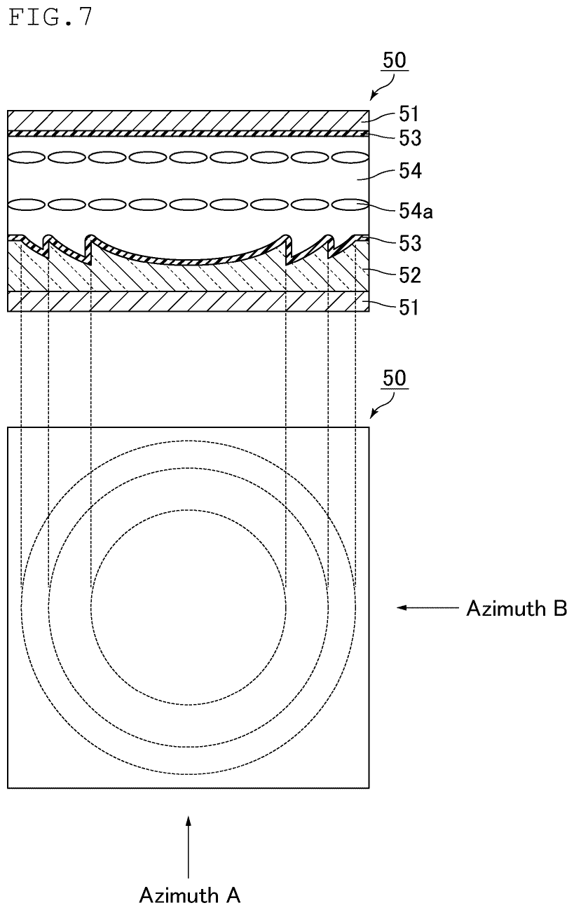

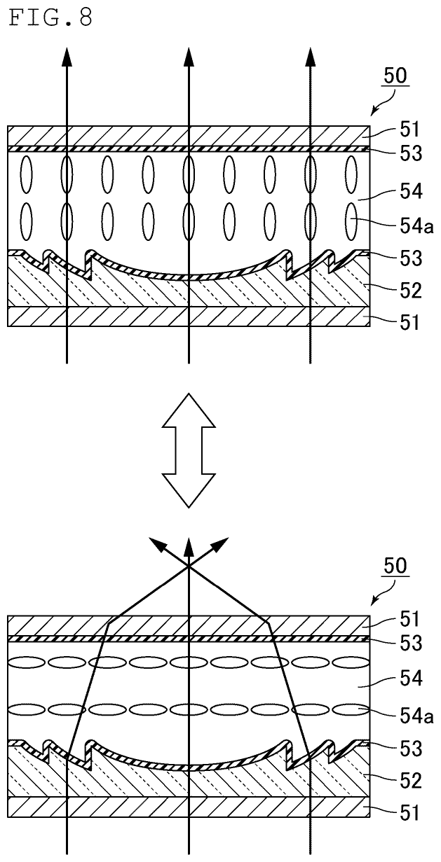

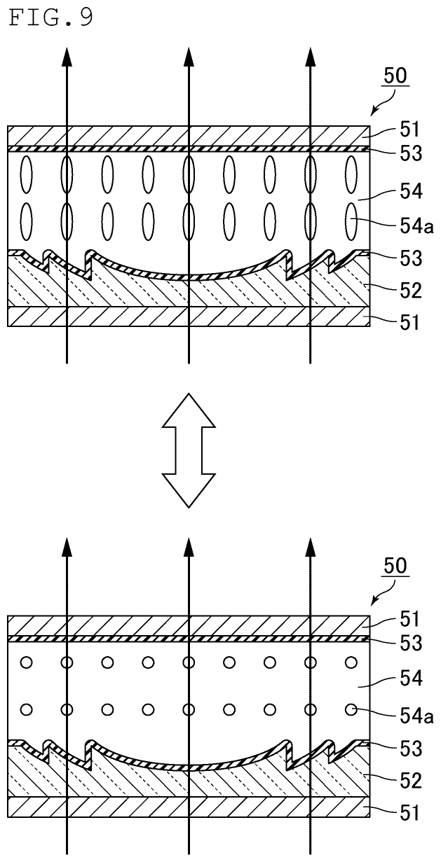

The refractive lenses are described with reference to FIGS. 7 to 9. FIG. 7 shows the structure of a refractive lens made of a resin, with the upper part showing a cross-sectional view and the lower part showing a top view. FIG. 8 shows the operation of the refractive lens at an azimuth A indicated in FIG. 7, with the upper part showing the state with voltage applied to the liquid crystal layer and the lower part showing the state with no voltage applied to the liquid crystal layer. FIG. 9 shows the operation of the refractive lens at an azimuth B indicated in FIG. 7, with the upper part showing the state with voltage applied to the liquid crystal layer and the lower part showing the state with no voltage applied to the liquid crystal layer. The arrows in FIGS. 8 and 9 indicate the paths of light transmitted through the refractive lens.

The refractive lens has a structure in which a glass substrate 51, a Fresnel lens 52 made of a resin, an electrode 53, a liquid crystal layer 54, an electrode 53, and a glass substrate 51 are laminated. For example, when the liquid crystal layer 54 includes a positive liquid crystal 54a (the major axes of the liquid crystal refractive index ellipsoids are oriented along the electric fields), the molecules of the liquid crystal 54a are aligned horizontally with no voltage applied (the lower parts of FIGS. 8 and 9) while the molecules of the liquid crystal 54a are aligned vertically with voltage applied (the upper parts of FIGS. 8 and 9). The combination of the refractive indices of the resin constituting the Fresnel lens 52 and the liquid crystal 54a is not limited. For example, the refractive index of the resin is set to about 1.5, ne (major axis refractive index) of the liquid crystal 54a is set to 1.8, and no (minor axis refractive index) of the liquid crystal 54a is set to 1.5. At this time, as shown in FIG. 8, at the azimuth A, the path of light is bent due to the refractive index difference with no voltage applied, and the path of light is not bent due to no refractive index difference with voltage applied. In contrast, as shown in FIG. 9, at the azimuth B, no refractive index difference arises both in the state with no voltage applied and in the state with voltage applied, so that the lens function is always not exerted.

The liquid crystal lens 50 may be a Pancharatnam-Berry phase lens. A Pancharatnam-Berry phase lens is a liquid crystal lens that can switch between the modes of divergence and convergence depending on the handedness of the circularly polarized light (e.g., U.S. Pat. No. 10,379,419 B). For example, the Pancharatnam-Berry phase lens functions as a lens whose focal length is switchable between f and −f for left-handed circularly polarized light and right-handed circularly polarized light. The focal length f of an active Pancharatnam-Berry phase lens can be controlled, in principle, by liquid crystal alignment period. In the present embodiment, a fixed lens with a focal length of f is added separately to change the focal lengths to be switched to enable focal length adjustment. Thus, adding a fixed lens with a focal length of f, for example, enables switching between a focal length of f/2 and a focal length of 0. Also, since circularly polarized light can be produced by adding a λ/4 plate to a linear polarizer, almost the same action can be exerted using almost the same configuration as in the case of linearly polarized light by adjusting the optical power of the lens separately added.

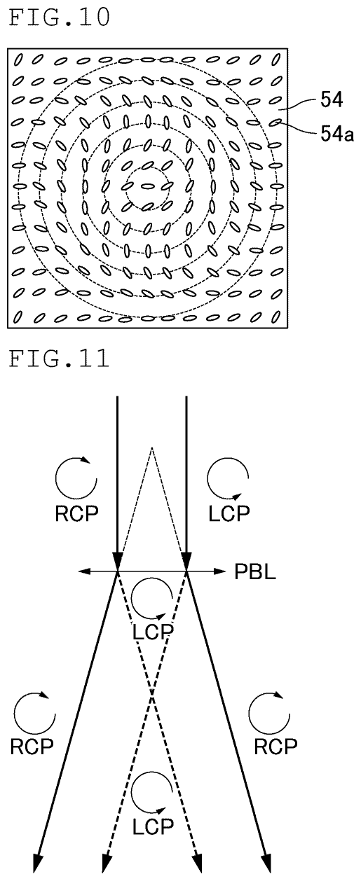

FIG. 10 is a top view showing the configuration of a Pancharatnam-Berry phase lens. FIG. 11 shows the functions of a Pancharatnam-Berry phase lens. The Pancharatnam-Berry phase lens uses a Pancharatnam-Berry phase (PB alignment) where the periodic molecular alignment of the liquid crystal 54a as shown in FIG. 10 causes diffraction to enable the lens function. In FIG. 11, the path of right-handed circularly polarized light RCP emitted from a Pancharatnam-Berry phase lens PBL is indicated by the solid line, and the path of left-handed circularly polarized light LCP emitted from the Pancharatnam-Berry phase lens PBL is indicated by the dotted line. The Pancharatnam-Berry phase lens PBL in FIG. 11 causes incident right-handed circularly polarized light RCP to converge while causing incident left-handed circularly polarized light LCP to diverge, and the handedness of circularly polarized light emerging from the lens is reversed. As described above, the Pancharatnam-Berry phase lens can switch between divergence and convergence at the focal point f by switching the handedness of the incident circularly polarized light.

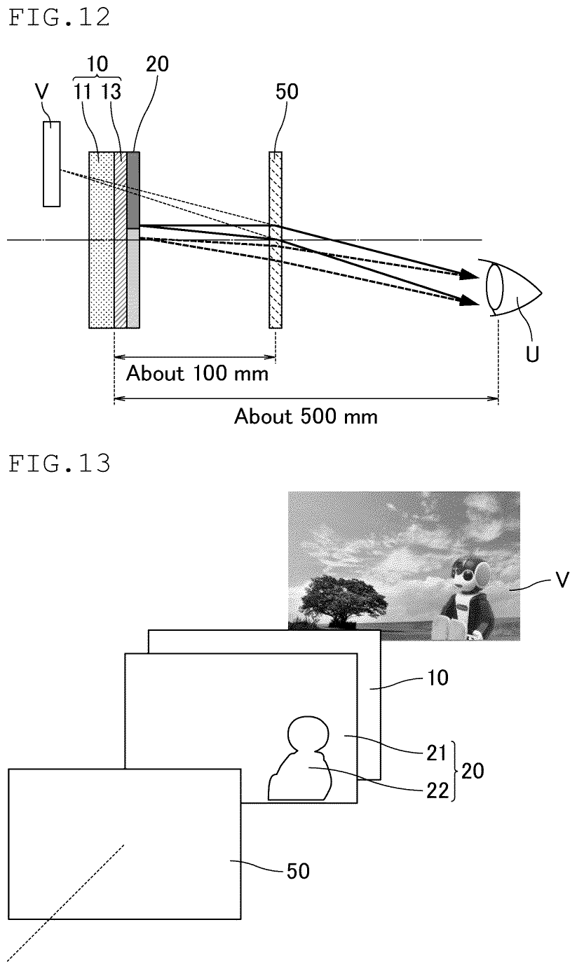

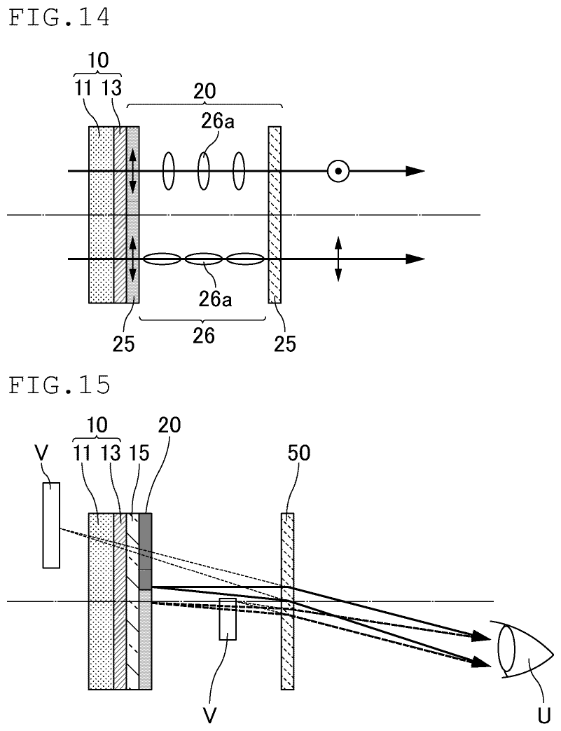

FIG. 12 is a side view showing an example of a specific configuration of a display device of Embodiment 1. FIG. 13 is a bird's-eye view of the display device shown in FIG. 12. FIG. 14 is an enlarged cross-sectional view of the surface-divided polarization conversion component of Embodiment 1. The display device shown in FIG. 12 is a 3D display including the display 11 at a viewing distance of about 500 mm and the liquid crystal lens 50 at a position 100 mm spaced from the display 11. The liquid crystal lens 50 is a refractive lens and the focal length thereof is about 100 mm. The viewing distance is set to about 500 mm because the distance required when the humans see a middle-sized (up to about 20-inch) display is generally 500 mm.

The surface-divided polarization conversion component (liquid crystal panel) 20, which can switch between introducing or not introducing a phase difference of λ/2 (i.e., 275 nm to light with a wavelength of 550 nm) is placed on the screen of the display 11. The liquid crystal panel can be in a liquid crystal mode commonly used in liquid crystal panels, such as the TN mode, the VA mode, the ECB mode, the IPS mode, or the FFS mode. In an example in the VA mode, a configuration can be employed in which no phase difference is introduced in the voltage-off state and a phase difference of λ/2 is introduced in the voltage-on state. The surface-divided polarization conversion component 20 may be a stack of two liquid crystal panels to reduce wavelength dependence.

As shown in FIG. 14, the surface-divided polarization conversion component (liquid crystal panel) 20 can drive molecules of a liquid crystal 26a in each region in the liquid crystal layer 26 by applying voltage to the liquid crystal layer 26 held between the pair of substrates 25. The number of regions in the liquid crystal panel constituting the surface-divided polarization conversion component 20 may be equal to or less than the number of pixels in the display 11 overlaid therewith. FIG. 14 shows a VA-mode liquid crystal panel with the upper part in the voltage-on state and the lower part in the voltage-off state.

The linearly polarized light emitted from the display 11 undergoes no change in phase when transmitted through the surface-divided polarization conversion component 20 in the voltage-off state to thus emerge as the same linearly polarized light. Although the orientation of the liquid crystal lens 50 is not limited, a case is described where the liquid crystal lens 50 is placed not to act as a lens. In this case, transmitted light reaches the human eye in the same state as when emitted from the display, so that the screen of the display 11 is observed as is (the real image is observed).

When voltage application by the surface-divided polarization conversion component 20 is turned on, light emitted from the display 11 is converted to linearly polarized light with its vibration direction rotated 90 degrees. In this case, the liquid crystal lens 50 acts as a lens when the linearly polarized light is transmitted therethrough. Since the display 11 is placed at the distance equal to the focal length of the liquid crystal lens 50, the lens action makes the linearly polarized light into almost parallel light, which then reaches the user U's eyes. Thus, the display 11 appears to be almost at infinity to the user U (the user U sees the virtual image).

As described above, since the surface-divided polarization conversion component 20 can be used to switch between the real image and the virtual image, two virtual image planes at different distances can be viewed at the same time owing to the surface division, so that display with depth (3D display) can be viewed. For example, a character display region intended to be the foreground may be set as the non-conversion part 22 (region with a phase difference of zero) and the background region to be a distant view may be set as the conversion part 21 (region with a phase difference of λ/2).

In the configuration above, for simplification, the display 11 is placed at the focal length and the virtual image is set at infinity. The focal length of the liquid crystal lens 50 or the distance from the liquid crystal lens 50 to the display 11 can be changed to set the virtual image at the desired position. Since the focal length of the liquid crystal lens 50 can be adjusted by voltage, increasing the voltage applied to the liquid crystal lens 50 can also move the virtual image distance from infinity toward the user. As shown in FIG. 8, the liquid crystal lens 50 has the maximum focal length in the voltage-off state.

FIG. 15 is a side view showing another example of the specific configuration of the display device of Embodiment 1. The display device shown in FIG. 15 is a 3D display, and the liquid crystal lens 50 is a Pancharatnam-Berry phase lens (PB lens). The PB lens is a lens that can change the refractive power thereof (concave/convex lenses), and thus allows active on/off switching in principle. In other words, adjusting the alignment pitch of the liquid crystal enables adjustment of the lens power.

A PB lens switches its function between a concave lens and a convex lens depending on the handedness of circularly polarized light, so that two virtual images V can be formed in front of and behind the display 11. When a PB lens is used, a circular polarizer obtained by combining the polarizing plate 13 and a λ/4 plate 15, for example, is used to convert light emitted from the display 11 to circularly polarized light. On the circular polarizer, the surface-divided polarization conversion component 20 capable of converting one-handed circularly polarized light to the opposite-handed circularly polarized light is placed to switch the handedness of the circularly polarized light.

The surface-divided polarization conversion component 20 can switch between two virtual image planes. This allows the user to see two planes at different distances at the same time owing to the surface division to provide display with depth (3D display), thus enhancing the sense of immersion in the VR and allowing smooth gaze switching.

### Embodiment 2

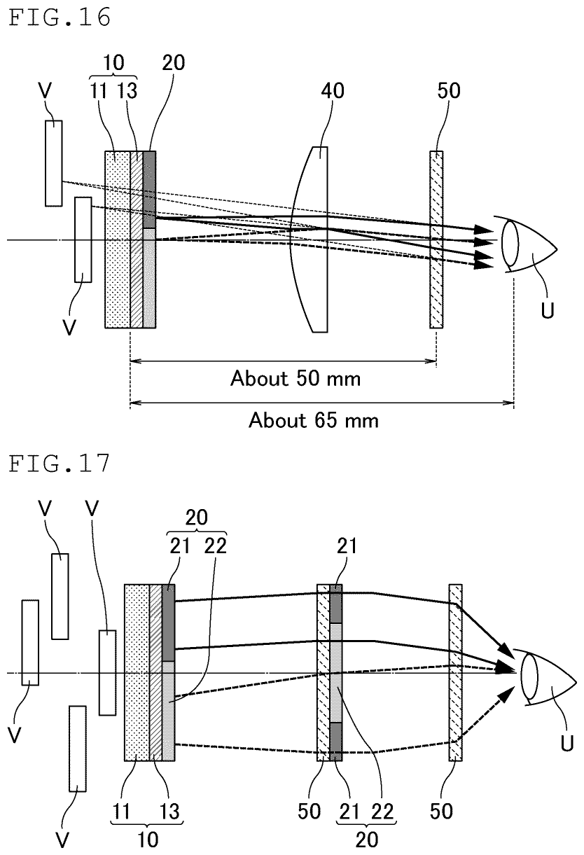

FIG. 16 is a side view schematically showing the configuration of a display device of Embodiment 2. The display device of the present embodiment includes a different lens other than a liquid crystal lens. Specifically, a physical lens 40 whose focal length is 100 mm and a liquid crystal lens 50 whose focal length is 100 mm are supposed to be proximally positioned or attached to each other with the liquid crystal lens 50 being spaced 50 mm from the display 11, and the display 11 is supposed to be viewed as a VR display at a viewing distance of about 65 mm.

In the case of VR, a lens is used to magnify the images on the screen to a certain times (e.g., about 10 times) their original size to allow the user to focus their eyes on the screen. The liquid crystal lens 50, which does not act as a lens at some azimuths, is thus used in combination with the physical lens (common lens) 40.

As in Embodiment 1, the surface-divided polarization conversion component (liquid crystal panel) 20 is placed on the screen of the display 11. The liquid crystal mode of the liquid crystal panel and the driving conditions of the liquid crystal lens are the same as in Embodiment 1.

A difference from Embodiment 1 is that the physical lens 40 used in combination magnifies the images on the screen even at azimuths where the liquid crystal lens 50 does not act as a lens, so that the user sees virtual images, not the real image.

The surface-divided polarization conversion component 20 of Embodiment 2 can also switch between two virtual image planes. This allows the user to see two planes at different distances owing to the surface division to provide display with depth (3D display), thus enhancing the sense of immersion as VR and allowing smooth gaze switching.

The different lens may be a Fresnel lens or a diffractive lens instead of the physical lens 40.

### Embodiment 3

FIG. 17 is a side view schematically showing the configuration of a display device of Embodiment 3. The display devices of Embodiments 1 and 2 each include one set of a surface-divided polarization conversion component and a liquid crystal lens. Yet, the display device of Embodiment 3 includes multiple sets of the surface-divided polarization conversion component 20 and the liquid crystal lens 50. Use of multiple sets (N sets) enables production of 2^{N} virtual image planes. The use, however, complicates driving and the later-described image processing, for example.

The surface-divided polarization conversion component 20 is better to be placed close to the display surface in principle. This is because the boundary between virtual images V can be clearly defined on the display image. When the surface-divided polarization conversion component 20 is moved away from the display surface as shown in FIG. 18, the pixels in the boundary may be included in both of the two virtual image planes. This boundary problem can be resolved by using the later-described image processing or other technique in combination.

As described above, use of multiple sets of the surface-divided polarization conversion component 20 and the liquid crystal lens 50 enables switching among 2^{N} virtual image planes. Thus, the user can view 2^{N} planes at different distances at the same time owing to the surface division and can thus view display with depth (3D display). This can enhance the sense of immersion as VR and allows smooth gaze switching.

### Embodiment 4

Two virtual image planes generated using a surface-divided polarization conversion component in some cases cause the videos to overlap in their boundary or generate a region with no video, depending on the positions of the user's eyes and the depths of the virtual images (distances from the user). These issues arise due to the difference in magnification between the two virtual image planes and the positional movement of the eyes.

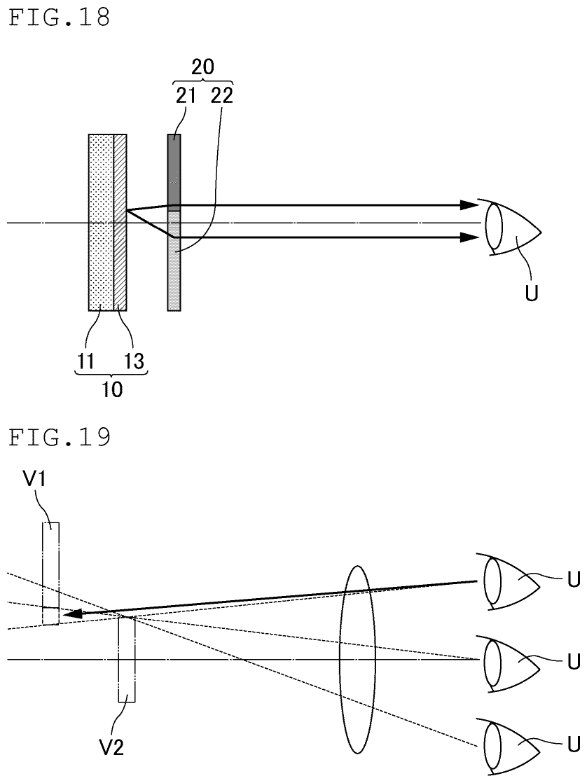

FIG. 19 shows the generation principle of an overlap and a gap between videos. As shown in FIG. 19, when the user U's eyes are positioned on the line normal to the center of the lens, there is no overlap between a virtual image V1 and a virtual image V2 in an ideal state where there is no distortion in the optical system. In practice, the positions of the eyes may be slightly shifted from the line normal to the center of the lens when the user puts on the HMD enclosure. The shift may cause the virtual image V1 and the virtual image V2 to appear overlapped or generate a gap with no video between the virtual image V1 and the virtual image V2. When the positions of the user U's eyes are shifted closer to the upper end of the virtual image V2 from the assumed positions, the user cannot see the bottom part of the virtual image V1, which is supposed to be seen by the user (i.e., the gap appears black with no video). When the positions of the user U's eyes are shifted farther from the upper end of the virtual image V2 from the assumed positions, the user sees the overlapped bottom part of the virtual image V1, which is not supposed to be seen by the user. Such an overlap or gap between virtual images is not affected by the eye rotation. This is based on the same principle as when rotating the eyes does not reveal the dotted line portion of the virtual image V1 behind the virtual image V2.

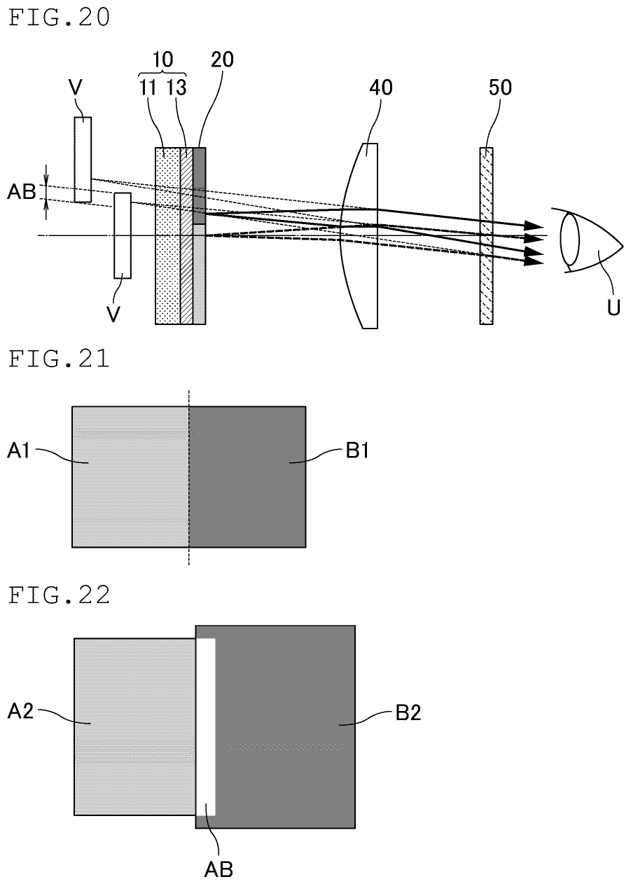

FIG. 20 is a side view schematically showing the configuration of a display device with an overlap between virtual images. FIG. 21 is a front view of an example of a display surface when there is an overlap between virtual images. FIG. 22 is a front view of an example of a video when there is an overlap between virtual images. As shown in FIG. 21, the original image on the display surface is defined by an image A1, which is displayed in the region where the phase difference of the surface-divided polarization conversion component 20 is zero, and an image B1, which is displayed in the region where the phase difference of the surface-divided polarization conversion component 20 is λ/2, and the image A1 and the image B1 are of the same size. In contrast, the video (enlarged image) obtained by light emitted from the display surface and transmitted through the surface-divided polarization conversion component 20 is defined by, as shown in FIG. 22, the image A1, which is displayed as a virtual image A2 at a close distance, and the image B1, which is enlarged and displayed as a virtual image B2 at a far distance, and there is an overlap between the virtual image A2 and the virtual image B2. In an overlap region AB between the virtual images, the brightness is simply the sum of the quantities of lights, making the region appear bright. Since the far virtual image B2 is usually hidden by the close virtual image A2, such bright display should appear unnatural except for cases where such display is acceptable as visual effects. In addition, the amount of overlap depends on the positions of the eyes, meaning that the amount of overlap is not much affected by the eye movement (rotation) but greatly affected (the amount of overlap is changed) by the positional shift of the eyes.

In the present embodiment, the overlapping region between the first image and the second image (overlap between virtual image planes) may be subjected to image correction (first image correction). Examples of the first image correction include the following.

### (1) First Image Correction

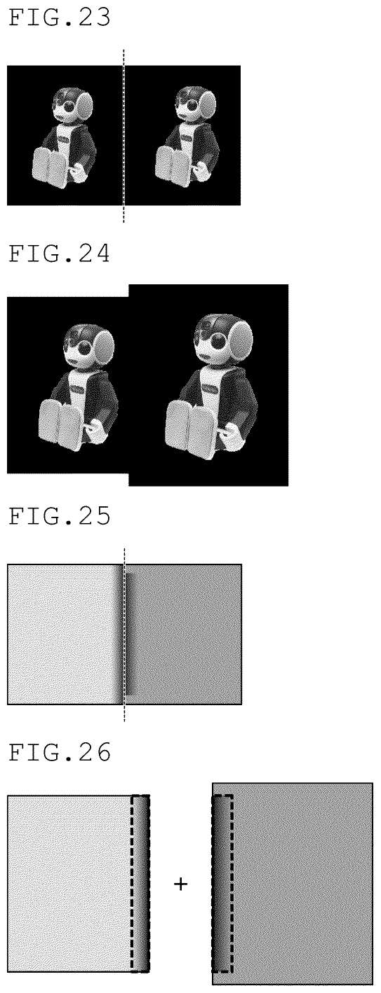

Examples of the first image correction include processing (first correction) which makes the overlapping region (where there is an overlap between virtual images) appear black as shown in the original image in FIG. 23 and the enlarged image in FIG. 24. This can be the fundamental solution to the image overlapping.

The first image correction may be processing (second correction) which decreases the luminance of at least one of the first image or the second image in the overlapping region as shown in the original image in FIG. 25 and the enlarged image in FIG. 26. Specifically, gradients may be added to the luminance in the overlapping region. FIG. 25 shows the first image and the second image depicted with a simple luminance distribution, but the images may be weighted such that, for example, the luminance of the front image coming in front is closer to the original luminance and the luminance of the image at the back is lower than the original luminance.

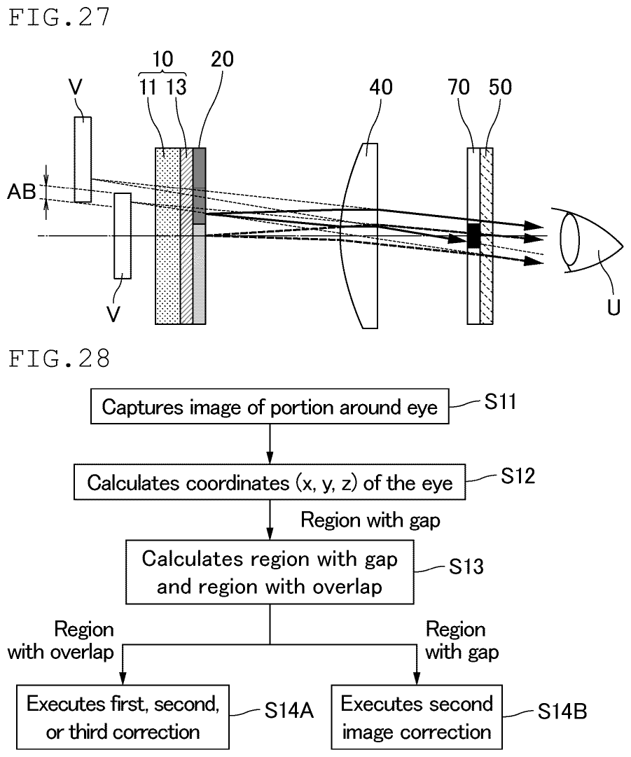

The first image correction may be, as shown in FIG. 27, placing a guest-host liquid crystal layer 70 between the surface-divided polarization conversion component 20 and the liquid crystal lens 50 (third correction). The guest-host liquid crystal layer 70 is preferably placed near the liquid crystal lens 50, more preferably adjacent to the liquid crystal lens 50. The guest-host liquid crystal layer 70 used includes a light absorbing material as the guest material and a liquid crystal as the host material. Examples include one in which the guest material is a uniaxial light absorbing material and the liquid crystal used as the host material is a vertical alignment liquid crystal. Such a guest-host liquid crystal layer 70 can be set such that it does not absorb light in the voltage-off state and absorbs only polarized light with either one of the vibration directions in the voltage-on state. As shown in FIG. 27, when the guest-host liquid crystal layer 70 is placed such that it can absorb only polarized light for displaying a distant view (distant virtual image) in the overlapping region between the virtual images V, the user can see only light for displaying the close view (close virtual image). The later-described eye tracking may be used in combination to adjust the position of the guest-host liquid crystal layer 70.

The first image correction may include determining the overlapping region based on the amount of overlap between the first image and the second image detected by eye tracking. As described above, the position of overlap is shifted depending on the positions of the user's eyes, and the images can be properly corrected instantly by the eye tracking technology. Use of the eye tracking technology in combination with the first measure and/or the second measure allows more effective prevention of the unnatural display due to the overlap between virtual images. Specifically, for example, the positions of the user's eyes are identified by the eye tracking technology and the gradients of the luminance in the second measure are corrected every time the positions are identified. Also, when the distant view (distant virtual image) in the overlap between the virtual images is made black, the images appear in the front and back naturally without any overlap therebetween when enlarged.

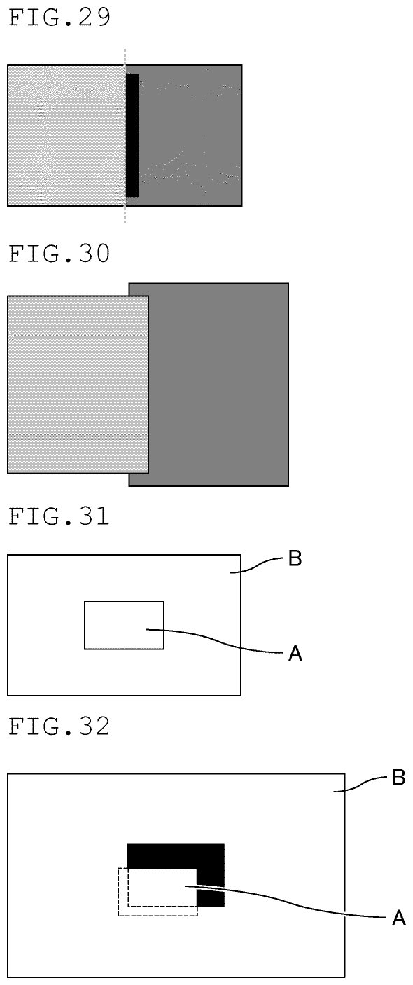

FIG. 28 is a flowchart showing an example of image correction when the eye tracking technology is used. As shown in FIG. 28, first, an imager such as a camera is used to capture images of the portions around the user's eyes (step S11). Next, from the information in the images of the portions around the eyes, three-dimensional coordinates (x,y,z) of the positions of the eyes are calculated (step S12). The three-dimensional coordinates are sufficient as long as they can identity the positions of the eyes and may not include information on the eye rotation. Based on the three-dimensional coordinates of the positions of the eyes, regions where a gap between virtual images is generated and regions where an overlap between the virtual images is generated are calculated (step S13). Based on the calculation results, if there is an overlap between the virtual images, the first, second, or third correction described above is executed (step S14A). Such an eye tracking technology allows accurate identification of the regions where there is an overlap between the virtual images as shown in the original image in FIG. 29 and the enlarged image in FIG. 30, and the image correction can be applied to the identified regions. If there is a gap between the virtual images, the second image correction described later is executed (step S14B).

In the present embodiment, image correction (second image correction) may be applied to the boundary region between the first image and the second image (gap between the virtual images).

### (2) Second Image Correction

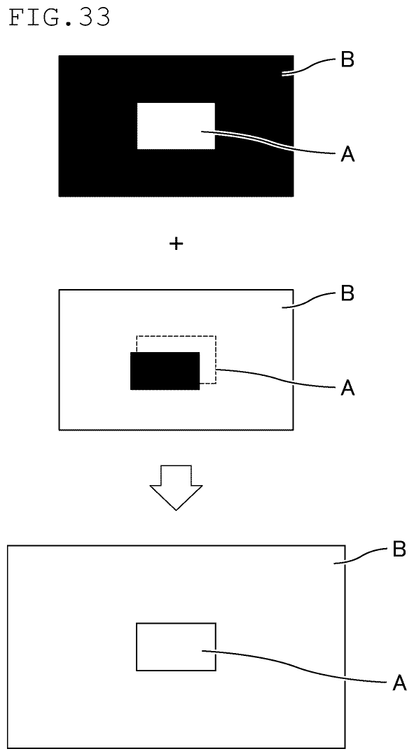

Examples of the second image correction include time-divisionally displaying the boundary region between the first image and the second image. FIG. 31 shows the generation principle of a gap between virtual images, showing the original image. FIG. 32 shows the generation principle of a gap between virtual images, showing an enlarged image. FIG. 33 shows time-division display.

The image A and the image B, defining the original image with no gap in between as shown in FIG. 31, may appear with a gap (black region) in between when defining an enlarged image (video as seen by the human eyes) as shown in FIG. 32, due to the positional shift of the user's eyes or distortion in the optical system. In FIG. 32, there is also a region with an overlap between the image A and the image B. A measure against such a gap or overlap may be correction to superimpose the image A and the image B by time-division display. The correction may include adjusting the position and size of the image A and/or the image B. Time-divisionally displaying at least the boundary region between the image A and the image B can prevent a region with no display (appearing black) when the images are enlarged. The time-divisional display includes simultaneous switching on the display and on the surface-divided polarization conversion component.

The images are not needed to be time-divisionally displayed in the portion other than the portion corresponding to the boundary region, but are still desired to be adjusted such that the luminance does not differ between these portions. In other words, when the images A and B in FIG. 33 are lit alternately each for half the original one frame time in the overlapping region therebetween, the luminance in the overlapping region is halved. To equalize the luminance values, desirably, the luminance of only the overlapping region is doubled or the luminance of the surrounding region is halved.

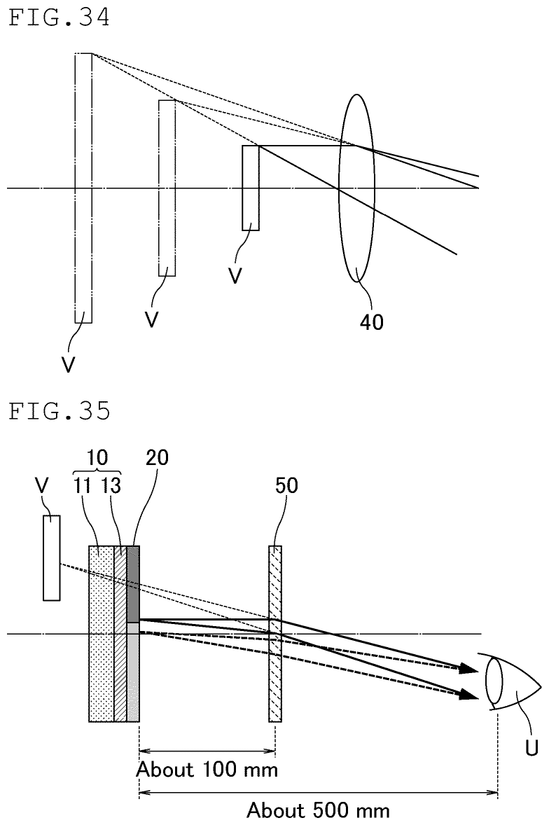

As shown in FIG. 34, in terms of the geometrical optics of a simple lens, a decrease in focal length (i.e., an increase in optical power) puts the virtual image V away and enlarges the virtual image V. Thus, in the case of FIG. 32, the virtual image V of the image A is at a close position and the virtual image V of the image B is at a distant position.

### Embodiment 5

FIG. 35 is a side view schematically showing the configuration of a display device of Embodiment 5. Although the embodiments above use a voltage-variable liquid crystal lens, a static (invariable) liquid crystal lens 50 made of a UV-cured liquid crystal material may be used. In the present embodiment, since a static liquid crystal lens 50 is used, the virtual image V cannot be moved by voltage, but two virtual images (including cases of real images) V can be switched by the surface-divided polarization conversion component 20. Thus, this embodiment is advantageous in that the production is possible at low cost, and the electrically conductive lines are gathered in the display 11 as the liquid crystal lens 50 requires no electrically conductive lines. The embodiment is thus applicable to VR, for example.

The surface-divided polarization conversion components of the present invention can generate two images at different virtual image distances, thus easing the burden on the user (viewer) during viewing of the display device or enhancing the sense of immersion into the content. Specific examples of application include application to a VR display device so that the device can display a close view (close virtual image) and a distant view (distant virtual image) as VR images.

### REFERENCE SIGNS LIST

10: display panel
11: display
13: polarizing plate
15: λ/4 plate
20: surface-divided polarization conversion component
21: conversion part
22: non-conversion part
25: substrate
26: liquid crystal layer
26a: liquid crystal
40: lens (physical lens)
50: liquid crystal lens
51: glass substrate
52: Fresnel lens
53: electrode
54: liquid crystal layer
54a: liquid crystal
70: guest-host liquid crystal layer
A, A1, B, B1: image
A2, B2: virtual image
AB: overlap between virtual images
D1: focus adjustment distance
D2: convergence distance
I1, I2: video
12a: blurred video
R: video intended for the right eye
RCP: right-handed circularly polarized light
RE: right eye
L: video intended for the left eye
LCP: left-handed circularly polarized light
LE: left eye
U: user (viewer)
V, V1, V2: virtual image

What is claimed is:

1. A surface-divided polarization conversion component comprising, in a plan view:
a first transmissive part which transmits polarized light for a first image; and
a second transmissive part which transmits polarized light for a second image,
the second transmissive part introducing a phase difference different by λ/2 from a phase difference introduced by the first transmissive part.

2. The surface-divided polarization conversion component according to claim 1,
wherein the first transmissive part is a non-conversion part which transmits polarized light for a first image without converting a polarization state of the polarized light, and
the second transmissive part is a conversion part which converts a polarization state of polarized light for a second image by introducing a phase difference of λ/2 to the polarized light for a second image.

3. The surface-divided polarization conversion component according to claim 2,
wherein the conversion part includes a resin layer with a phase difference of λ/2.

4. The surface-divided polarization conversion component according to claim 1,
wherein the second transmissive part in a cross-sectional view includes a pair of substrates and a liquid crystal layer placed between the pair of substrates, and
the second transmissive part introduces a phase difference that is variable depending on voltage applied to the liquid crystal layer.

5. A display device comprising:
a display panel configured to emit polarized light for a first image and polarized light for a second image;
the surface-divided polarization conversion component according to claim 1 placed at a position where the polarized lights enter; and
an optical element placed at a position where the polarized lights transmitted through the surface-divided polarization conversion component enter,
the optical element being configured to make a virtual image distance of a first image generated from the first polarized light transmitted through the first transmissive part different from a virtual image distance of a second image generated from the second polarized light transmitted through the second transmissive part.

6. The display device according to claim 5,
wherein the optical element is a liquid crystal lens, and
the liquid crystal lens acts as a lens with a first focal length for the first polarized light and does not act as a lens or acts as a lens with a second focal length for the second polarized light.

7. The display device according to claim 6,
wherein the liquid crystal lens is a refractive lens, a gradient-index lens, or a diffractive lens.

8. The display device according to claim 6,
wherein the liquid crystal lens is a Pancharatnam-Berry phase lens.

9. The display device according to claim 6,
wherein the liquid crystal lens includes a liquid crystal layer and has a focal length that is variable depending on voltage applied to the liquid crystal layer.

10. The display device according to claim 5, further comprising a different lens other than a liquid crystal lens.

11. The display device according to claim 6, further comprising a combination of a different surface-divided polarization conversion component and a different liquid crystal lens.

12. The display device according to claim 5,
wherein the display device is configured to execute first image correction for an overlapping region between the first image and the second image.

13. The display device according to claim 12,
wherein the first image correction includes making the overlapping region appear black.

14. The display device according to claim 12,
wherein the first image correction decreases luminance of at least one of the first image or the second image in the overlapping region.

15. The display device according to claim 12,
wherein the first image correction includes determining the overlapping region based on an amount of overlap between the first image and the second image detected by eye tracking.

16. The display device according to claim 5, further comprising a guest-host liquid crystal layer between the surface-divided polarization conversion component and the optical element,
wherein the guest-host liquid crystal layer contains a light absorbing material as a guest material and contains a liquid crystal as a host material.

17. The display device according to claim 5,
wherein the display device is configured to execute second image correction for a boundary region between the first image and the second image.

18. The display device according to claim 17,
wherein the second image correction includes superimposing the first image and the second image by time-division display.

19. The display device according to claim 5, which is a VR display device or a 3D display device.

20. The display device according to claim 5, which is a head-mounted display device.
